(19) United States
(12) Patent Application Publication
(10) Pub. No.: US 2005/0122915 A1
(43) Pub. Date: Jun. 9, 2005

(54) Communication apparatus

(75) Inventor: Akira Norizuki, Shizuoka (JP)

Correspondence Address: ARMSTRONG, KRATZ, QUINTOS, HANSON & BROOKS, LLP, 1725 K STREET, NW, SUITE 1000, WASHINGTON, DC, 20006, US

(73) Assignee: YAZAKI CORPORATION, Tokyo (JP)

(21) Appl. No.: 11/002,219

(22) Filed: Dec. 3, 2004

(30) Foreign Application Priority Data
Dec. 5, 2003 (JP) 2003-407760
Oct. 21, 2004 (JP) 2004-306751

(51) Int. Cl. H04L 12/28

(52) U.S. Cl. 370/282; 370/408; 370/432

(57) ABSTRACT

An input device of a communication apparatus connected with a transmission line is connected with an upper other communication apparatus and an output device of the communication apparatus is connected with a lower other communication apparatus. A datum inputted from the input device is set as its identification datum of the communication apparatus by an identification data setting device. An identification datum of the lower other communication apparatus is generated with reference to the identification datum by an identification data generating device. The identification datum is outputted by an output control device to input the identification datum to the lower other communication apparatus connected with the output device. A communication device communicates according to the identification data set by the identification data setting device.

The priority application Number Japan Patent Application No. 2003-407760 upon which this patent application is based is hereby incorporated by reference.

### BACKGROUND OF THE INVENTION

1. Field of the Invention

This invention relates to a communication apparatus and a communication system, especially the communication apparatus, which is connected with a transmission line and communicates with other communication apparatuses connected with the transmission line with reference to an identification datum to be assigned to each communication apparatus, and the communication system which includes a master communication apparatus connected with the transmission line and a plurality of slave communication apparatuses connected with the transmission line, and communicates through the transmission line with reference to the identification datum to be assigned to each communication apparatus.

2. Description of the Related Art

Electronic devices for an automobile have progressed and are diversified. Recently, the number of the electric devices that are installed in the automobile has increased rapidly. A Local Area Network (LAN) in the automobile has been developed to reduce the amount of wiring required for a wiring harness which is required for the increased number of the electronic devices. The LAN controls precisely the electronic devices in real time by communicating data of respectively controlled sensors and electric devices.

The LAN in the automobile includes a main network, and a plurality of sub networks, for example, a body system, a safety system, a power train system, an information system, a battery system and a like, connected with the main network via a transmission line. A Controller Area Network (CAN) is applied for a communication protocol of the main network. Various LAN are structured for respective sub networks, and various communication protocols suitable for respective purposes are applied thereto.

In a multiplex transmission apparatus used in the both networks mentioned above, a node of a switch system, a node of a lamp system, a node of a display system, a node of the battery system, and a like are connected with the transmission line. Each node is connected with input devices, for example, a plurality of switches or output devices, such as a plurality of lamps. Each node multiplexes data inputted through the plurality of input devices connected with its node, and generates a frame by adding a unique identification datum (ID) for identifying the data. Each node transmits the frame through the transmission line to the other node. Thus, multiplex transmission between each node is operated.

A multiplex transmission apparatus, in which a plurality of nodes shares one ID for assigning IDs efficiently, is generally provided. In the multiplex transmission apparatus, when the input device connected with the its node and the input device connected with an other node share the same ID according to a function of an input/output device, a transmission control device adds a first datum of the input device connected with the its node, and a transmission abort datum for aborting transmit permission of a second input datum of the input device connected with the other node onto a multiplexed datum, and transmits the multiplexed datum.

Thus, even if the first datum of the its node and the second datum of the other node share the same ID, the transmission abort datum prevents the its node from interfering with the second input datum of the input device connected with the other node. Thereby, the one ID can be shared by the plurality of nodes and the identification data can be assigned efficiently. Japan Patent Application No. 2000-83033 describes above features.

### SUMMARY OF THE INVENTION

Objects to be Solved

When the LAN in an automobile mentioned above is structured, each node is required to have respective ID. Thereby, even if the nodes have the completely same function (application program) each node is a dedicated device. Therefore, each node cannot be used commonly, and that causes a factor of increasing cost.

In a vehicle requiring high capacity electrical energy, for example, an electric automobile, a plurality of battery units is mounted. The node monitoring a condition of each battery unit is installed in each battery unit for maintaining stable running performance. The node is a dedicated device, so that the battery unit is also a dedicated device. Therefore, commonality of the nodes is required.

One method of assigning an ID to each one of arbitrary number of nodes is a method of detecting a voltage by a voltage drop. An accuracy of the method becomes worse according to increasing a number of nodes, and causes a malfunction of assignment.

To overcome the above problems, the objects of the present invention are to provide a communication apparatus, which can be used in common, and a communication system in which the communication apparatuses are used.

How to Attain the Object of the Present Invention

In order to attain the object of the present invention, a communication apparatus according to aspect of the present invention is connected with a transmission line and has a communication device, which communicates with other communication apparatuses connected with the transmission line L with reference to an identification datum to be assigned to each communication apparatus. The communication apparatus is characterized by including an input device, an output device, an identification data setting device, an identification data generating device, and an output control device. The input device is connected through a connecting cable with the upper other communication apparatus, which is connected with the transmission line L, and inputted a datum from the upper other communication apparatus. The output device is connected through the connecting cable with the lower other communication apparatus, which is connected with the transmission line L, and outputs the datum to the lower other communication apparatus. The identification data setting device sets the datum, which is inputted from the input device to the identification datum of the communication apparatus. The identification data generating device generates the identification datum of the lower other communication apparatus, which is connected with the output device, with reference to the identification datum set by the identification data setting device. The output control device controls the output device to output the identification datum to be generated by the identification data generating device. The communication device communicates with the other communication apparatuses with reference to the identification datum set by the identification data setting device.

The communication apparatuses according to above aspects of the present invention are connected with the transmission line so as to perform as a plurality of slave communication apparatuses of a communication system. The communication system includes a master communication apparatus connected with the transmission line, and communicates through the transmission line with reference to the identification datum to be applied to each communication apparatus. The plurality of slave communication apparatuses is connected in a row by sequentially connecting an output device of one slave communication apparatus and an input device of a next slave communication apparatus with the connecting cable. The master communication apparatus has a master-side output device, a start detecting device, a slave-apparatus identification data generating device, a master-side output control device. The master-side output device is connected with the input device of a front one of the slave communication apparatuses connected in a row. The start detecting device for detecting a start to assign the identification datum. The slave-apparatus identification data generating device for generating the identification datum of the slave communication apparatus connected with the master-side output device corresponding to a detection of the start to assign the identification datum by the start detecting device. The master-side output control device for controlling the master-side output device to output the identification datum to be generated by the slave-apparatus identification data generating device.

The above and other objects and features of this invention will become more apparent from the following description taken in conjunction with the accompanying drawings.

### BRIEF DESCRIPTION OF THE DRAWINGS

FIG. 1 is a block diagram of an embodiment of a communication apparatus and a communication system according to the present invention;

FIG. 2 is a schematic block diagram of an embodiment of the communication system according to the present invention;

FIG. 3 is a block diagram of an embodiment of an output device and an input device of the communication apparatus according to the present invention;

FIG. 4 is a flowchart of a first embodiment of process of assigning a master-side. ID executed by a CPU in a master communication apparatus;

FIG. 5 is a flowchart of the first embodiment of process of assigning a slave-side ID executed by a CPU in a slave communication apparatus;

FIG. 6 is a schematic diagram for describing an action according to the first embodiment of the process of assigning the IDs in the communication system;

FIG. 7 is a flowchart of a second embodiment of process of assigning a master-side ID executed by a CPU in a master communication apparatus;

FIG. 8 is a flowchart of the second embodiment of process of assigning a slave-side ID executed by a CPU in a slave communication apparatus.

### DESCRIPTION OF THE PREFERRED EMBODIMENTS

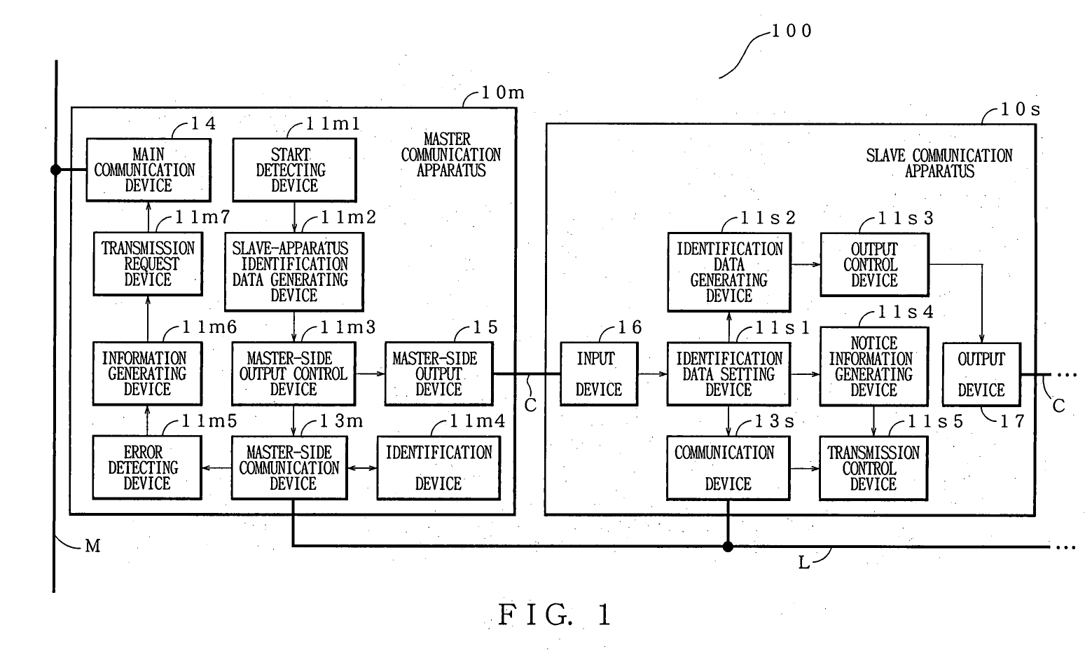

Embodiments of a communication apparatus and a communication system 100 according to the present invention will be described with reference to FIG. 1-8.

FIG. 1 is a block diagram of an embodiment of a communication apparatus and a communication system according to the present invention. As shown in FIG. 1, a communication apparatus 10s is connected with a transmission line L and has a communication device 13s, which communicates with other communication apparatuses connected with the transmission line L with reference to an identification datum to be assigned to each communication apparatus. The communication apparatus 10s includes an input device 16, an output device 17, an identification data setting device 11s1, an identification data generating device 11s2, and an output control device 11s3. The input device 16 is connected through a connecting cable C with the upper other communication apparatus 10s, which is connected with the transmission line L and inputted a datum from the upper other communication apparatus 10s. The output device 17 is connected through the connecting cable C with the lower other communication apparatus 10s, which is connected with the transmission line L, and outputs the datum to the lower other communication apparatus 10s. The identification data setting device 11s1 sets the datum, which is inputted from the input device 16 to the identification datum of the communication apparatus 10s. The identification data generating device 11s2 generates the identification datum of the lower other communication apparatus 10s, which is connected with the output device 17, with reference to the identification datum set by the identification data setting device 11s1. The output control device 11s3 controls the output device 17 to output the identification datum to be generated by the identification data generating device 11s2. The communication device 13s communicates with the other communication apparatuses 10s with reference to the identification datum set by the identification data setting device 11s1.

According to the communication apparatus 10s mentioned above, the output device 17 of the upper other communication apparatus 10s connected with the transmission line L is connected with the input device 16, and the input device 16 of the lower other communication apparatus 10s connected with the transmission line L is connected with the output device 17. Thereby, the identification datum is inputted to the next (lower) other communication apparatus 10s that is connected with the output device 17.

In the communication apparatus 10s, the identification data generating device 11s2 generates the identification datum of the lower other communication apparatus 10s to be serial to the identification datum set by the identification data setting device 11s1, as shown in FIG. 1.

The communication apparatuses 10s are connected with the transmission line L so as to perform as a plurality of slave communication apparatuses 10s of a communication system 100. The communication system 100 includes a master communication apparatus 10m connected with the transmission line L, and communicates through the transmission line L with reference to the identification datum to be applied to each communication apparatus 10m, 10s. The plurality of slave communication apparatuses 10s is connected in a row by sequentially connecting an output device 17 of one slave communication apparatus 10s and an input device 16 of a next slave communication apparatus 10s with the connecting cable C. The master communication apparatus 10m has a master-side output device 15, a start detecting device 11m1, a slave-apparatus identification data generating device 11m2, a master-side output control device 11m3. The master-side output device 15 is connected with the input device 16 of a front one of the slave communication apparatuses 10s connected in a row. The start detecting device 11m1 for detecting a start to assign the identification datum. The slave-apparatus identification data generating device 11m2 for generating the identification datum of the slave communication apparatus 10s connected with the master-side output device 15 corresponding to a detection of the start to assign the identification datum by the start detecting device 11m1. The master-side output control device 11m3 for controlling the master-side output device 15 to output the identification datum to be generated by the slave-apparatus identification data generating device 11m2.

According to the communication system 100 mentioned above, when a start of supplying electric power to the master communication apparatus 10m, or a start of assigning the identification data corresponding to receiving a start request is detected by the start detecting device 11m1, the slave-apparatus identification data generating device 11m2 generates the identification datum for the slave communication apparatus 10s connected with the master-side output device 15. The identification datum for the slave communication apparatus 10s is outputted from the master-side output device 15 to the slave communication apparatus 10s by the master-side output control device 11m3. The slave communication apparatus 10s sets the inputted identification datum as the identification datum of its node, and generates the identification datum of the next slave communication apparatus 10s connected with the output device 17 and outputs the datum from the output device 17 to the next apparatus. Such process is executed sequentially at the slave communication apparatuses 10s in a row, and the identification data are set sequentially.

In the communication system 100, the slave communication apparatus 10s further includes a notice information generating device 11s4 for generating a notice information to give notice of the identification datum set by the identification data setting device 11s1, and a transmission control device 11s5 for controlling the communication device 13s to transmit the notice information generated by the notice information generating device 11s4 to the master communication apparatus 10m. The master communication apparatus 10m further includes a master-side communication device 13m for communicating through the transmission line L, and an identification device 11m4 for identifying the transmittable slave communication apparatuses 10s with reference to the notice information received by the master-side communication device 13m corresponding to the output of the identification datum controlled by the master-side output control device 11m3. The master communication apparatus 10m communicates by the master-side communication device 13m with the slave communication apparatuses 10s identified by the identification device 11m4.

In the communication system 100, the transmission line L [connected with the communication device 13s and the master-side communication device 13m] structures a sub network. The master communication apparatus 10m further includes a main communication device 14, an error detecting device 11m5, an information generating device 11m6, and a transmission request device 11m7. The main communication device 14 is connected with a main transmission line M structuring a main network for communicating with a mating apparatus connected with the main transmission line M. The error detecting device 11m5 detects a communication error to be occurred between the master-side communication device 13m and the slave communication apparatus 10s. The information generating device 11m6 generates information of the communication error having the identification datum of the slave communication apparatus 10s corresponding to the communication error detected by the error detecting device 11m5 for giving notice of the communication error. The transmission request device 11m7 requests the main communication device 14 to transmit the information of the communication error generated by the information generating device 11m6 to the mating apparatus.

According to the communication system 100 mentioned above, when a communication error, for example no response and receiving an abnormal datum, occurred between the master-side communication device 13m and the slave communication apparatus 10s, is detected by the error detecting device 11m5, the information of the communication error having the identification datum of the slave communication apparatus 10s corresponding to the communication error is generated by the information generating device 11m6. When a transmission request device 11m7 requests the main communication device 14 to transmit the information of the communication error to the mating apparatus, the information of the communication error is transmitted to the mating apparatus by the main communication device 14.

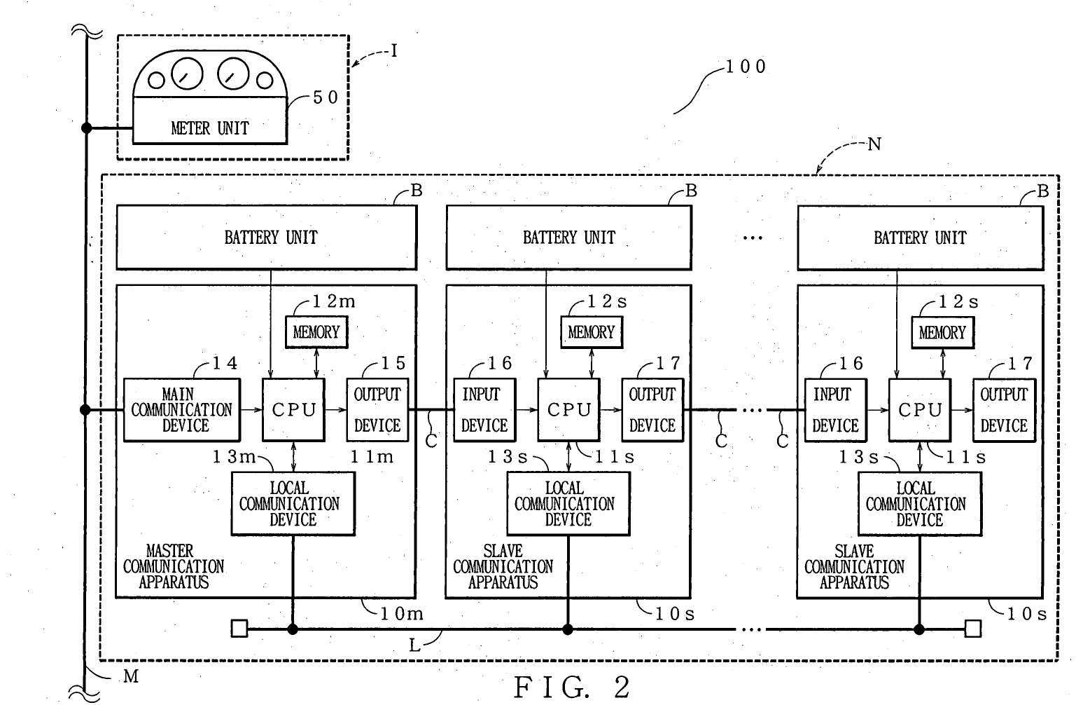

FIG. 2 is a schematic block diagram of the communication system 100 according to the present invention. In FIG. 2, a sub network N of a battery system and a sub network I of an information system are connected with a main transmission line (hereafter, called a main line) M of a main network. The sub network N and the sub network I communicate through the main transmission line M. When the sub network N and the sub network I have different protocols, a gateway (not shown) or an ECU (Electric Control Unit, not shown) is applied to the main line M.

The sub network I is installed in an instrumental panel (not shown) at a front of a driver who can recognize an indication of each meter (shown but not labeled) visually through a steering wheel (not shown) from a driver seat (not shown). The sub network I has a meter unit 50 (mating apparatus) provided with a plurality of display areas for showing traveling speed of a vehicle, engine rotating speed per unit time, remaining fuel amount in a fuel tank, temperature of cooling water for a engine, and a like. The meter unit 50 indicates various data received through the main line from the sub network N and other sub networks to the driver.

The sub network N has a transmission line (hereafter, called a sub line) L, and applies CAN (Controller Area Network) to a communication protocol of its network. A master communication apparatus (a master node) 10m and the n-sets (a plurality of) slave communication apparatuses (slave nodes) 10s, which structure the communication system 100, are connected with the sub line L. The master communication apparatus 10m and each one of the n-sets slave communication apparatuses 10s are connected respectively with a battery unit B.

Each battery unit B has functions of detecting voltage, detecting electric current, detecting temperature and a like, and outputs detected data to the master communication apparatus 10m or the slave communication apparatus 10s. The slave communication apparatus 10s transmits the inputted data thereto through the transmission line L to the master communication apparatus 10m. The master communication apparatus 10m transmits a datum inputted from the battery unit B connected therewith, and a datum received from the slave communication apparatus 10s, to the meter unit 50 (mating apparatus) connected with the main transmission line M. Thus, in this embodiment, the master communication apparatus 10m performs as a gateway in the sub network I.

The master communication apparatus 10m is provided with a central processing unit (CPU) 11m for executing various processes and control according to a predetermined program, and a memory 12m, for example, ROM, RAM, EEPROM, and a like, having a storage area for storing the program and a like for the CPU 11m and a working area required for processing in the CPU 11m.

The master communication apparatus 10m has a local communication device (the master-side communication device) 13m connected with the CPU 11m, and transmitting and receiving data through the transmission line L between slave communication apparatus 10s. When data are transmitted, the CPU 11m generates a frame having the data and a set identification datum (ID) stored in the memory 12m. By outputting the frame to the local communication device 13m, the frame is transmitted through the transmission line L to the slave communication apparatus 10s.

The master communication apparatus 10m further includes a main communication device 14 and an output device (master-side output device) 15. The main communication device 14 is connected with the CPU 11m, and transmits and receives data through the main transmission line M between other sub networks, for example, the meter unit 50 and a like.

The output device 15 is connected with a front one of the slave communication apparatuses 10s connected in a row, and includes a later-described Universal Asynchronous Receiver Transmitter (UART). The output device 15 converts parallel signals transmitted from the CPU 11m to serial signals, and outputs the serial signals. The output device 15 can be structured by a normal port or various devices. The UART has functions of re-transmission, parity check and a like so that reliability of the inputted and outputted data is improved by applying the UART.

The slave communication apparatuses 10s have the same basic structure as the master communication apparatus 10m mentioned above, and include a CPU 11s, a memory 12s, a local communication device 13s, an input device 16 to be inputted data from the other communication apparatus 10m, 10s, and an output device 17 outputting data via the connecting cable C to the other slave communication apparatus 10s.

The input device 16 of the slave communication apparatus 10s is connected with the output device 17 of an upper other slave communication apparatus 10s, which is adjacent to one side of the slave communication apparatus 10s, and connected with the transmission line L. The output device 17 of the slave communication apparatus 10s is connected with the input device 16 of a lower other slave communication apparatus 10s, which is adjacent to the other side of the slave communication apparatus 10s, and connected with the transmission line L. The input device 16 of the front one of the slave communication apparatuses 10s is connected with the output device 15 of the master communication apparatus 10m. The input device 16 and the output device 17 have respectively the UART as same as the output device 15. The input device 16 converts the serial signals transmitted from an outer apparatus to parallel signals and outputs the parallel signals to the CPU 11s. The output device 17 converts the parallel signals transmitted from the CPU 11s to serial signals and outputs the serial signals.

The memory 12m of the master communication apparatus 10m stores various programs to make the CPU 11m of the master communication apparatus 10m perform as a start detecting device 11m1 for detecting a start of assigning an identification datum, for example, a start of supplying electric power to each apparatus; a slave-apparatus identification data generating device 11m2 for generating an identification datum of the slave communication apparatus 10s connected with the master-side output device 15 according to detection of the start of assigning by the start detecting device 11m1, and a master-side output control device 11m3 for controlling the master-side output device 15 to output the identification data generated by the slave-apparatus identification data generating device 11m2.

The memory 12m stores various programs to make the CPU 11m of the master communication apparatus 10m perform as an identification device 11m4 for identifying the transmittable slave communication apparatuses 10s with reference to notice information received by the local communication device 13m (master-side communication device) corresponding to the output of the identification datum controlled by the master-side output control device 11m3.

The memory 12m stores various programs to make the CPU 11m of the master communication apparatus 10m perform as the error detecting device 11m5 for detecting a communication error to be occurred between the local communication device (master-side communication device) 13m and the slave communication apparatus 10s; an information generating device 11m6 for generating information of the communication error having the identification datum of the slave communication apparatus 10s corresponding to the communication error detected by the error detecting device 11m5 for giving notice of the communication error; and a transmission request device 11m7 for requesting the main communication device to transmit the information of the communication error generated by the information generating device 11m6 to the mating apparatus.

The memory 12s of the slave communication apparatus 10s stores various programs to make the CPU 11s of the slave communication apparatus 10s perform as an identification data setting device 11s1 for setting the datum inputted from the input device 16 to the identification datum of the slave communication apparatus 10s; an identification data generating device 11s2 for generating the identification datum of other communication apparatus connected with the output device 17 with reference to the identification datum set by the identification data setting device 11s1; and an output control device 11s3 for controlling the output device 17 to output the identification datum to be generated by the identification data generating device 11s2.

The memory 12s further stores various programs to make the CPU 11s of the slave communication apparatus 10s perform as a notice information generating device 11s4 for generating a notice information to give notice of the identification datum set by the identification data setting device 11s1, and a transmission control device 11s5 for controlling a local communication device (slave-side communication device) 13s to transmit the notice information generated by the notice information generating device 11s4 to the master communication apparatus 10m.

One example of a method of connecting n-sets slave communication apparatuses 10s with the master communication apparatus 10m is described herein. In this embodiment, each battery unit B is corresponded to the master communication apparatus 10m and the slave communication apparatuses 10s. Therefore, n+1 sets battery units B exist.

The local communication device 13m of the master communication apparatus 10m and the local communication devices 13s of the slave communication apparatuses 10s are connected with the transmission line L. The output device 15 of the master communication apparatus 10m and the input device 16 of the first slave communication apparatus 10s are connected through the connecting cable C. The output device 17 of the first communication apparatus 10s and the input device 16 of the second slave communication apparatus 10s are connected through the connecting cable C. Thus, the output device 17 of the one slave communication apparatus 10s and the input device 16 of the other communication apparatus 10s are connected through the cable C so as to connect the slave communication apparatuses 10s sequentially in a row. The input device 16 of the nth slave communication apparatus 10s is connected with the output device 17 of the (n−1)th slave communication apparatus 10s through the connecting cable C. The output device 17 of the nth slave communication apparatus 10s is connected with nothing.

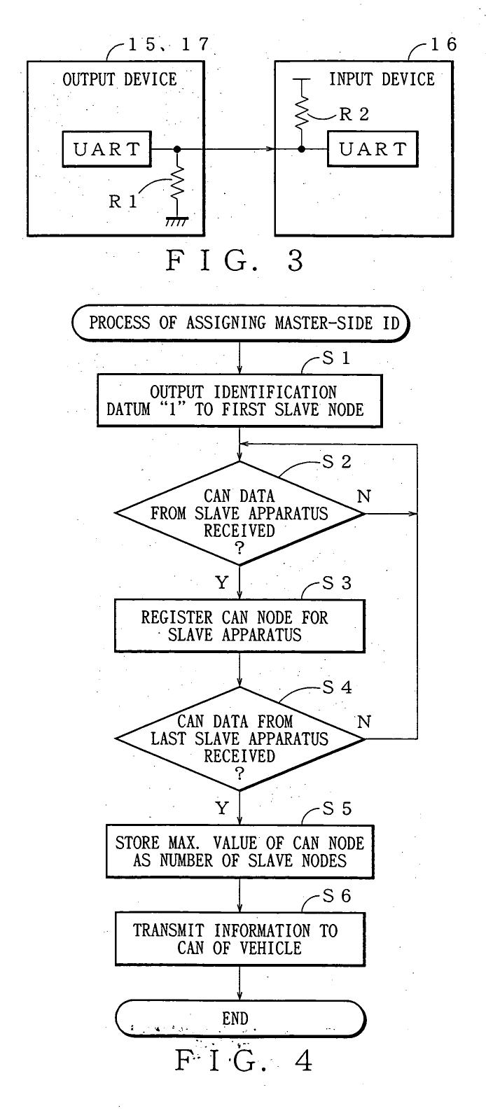

FIG. 3 is a block diagram of an example of an input device 16 and an output device 15 or 17 of the communication apparatus 10m or 10s. As shown in FIG. 3, the UARTs of the output devices 15, 17 are grounded through a resistor R1, and the UART of the input device 16 is connected through a resistor R2 with an electric power supply (battery unit B). When the UARTs of the output devices 15, 17 are not connected with the input device 16, the UARTs are in a Low level condition. When the UARTs of the output devices 15, 17 are connected with the input device 16, the UARTs are in a High level condition. Therefore, the CPU 11m, 11s can recognizes whether or not the output devices 15, 17 are connected with the input device 16 by monitoring the condition of the output devices 15, 17.

FIG. 4 is a flowchart of a first embodiment of a process of assigning a master-side ID executed by a CPU 11m in a master communication apparatus 10m. After the CPU 11m is started when electric power is supplied to the master communication apparatus 10m by turning an ignition switch of the vehicle (not shown) ON, that is, when the start of assigning the identification data is detected, the process of assigning a master-ID is called from an upper module.

In the step S1, “0” as the identification datum of the own node is set in the memory 12m, and the identification datum “1” of the front slave communication apparatus 10s connected with the (master-side) output device 15 is generated. The parallel signal of the identification datum is outputted to the output device 15. The serial signal converted from the parallel signal in the output device 15 is inputted to the input device 16 of the slave communication apparatus 10s, and the process proceeds to the step S2.

In the step S2, it is judged with reference to the input data from the local communication device 13m whether or not the CAN datum from the slave communication apparatus 10s is received. When it is judged that the CAN data is not received (N in the step S2), that is, when registering completion datum (notice information) informing completion of registering the identification datum at the slave communication apparatus 10s is not received, this judging process is repeated until the CAN data (registering completion datum) is received. When it is judged that the CAN data is received (Y in the step S2), there exists the slave communication apparatus 10s, in which the identification datum is registered completely, and the process proceeds to the step S3.

In the step S3, the slave node (identification datum) included in the received CAN datum is additionally stored sequentially in a predetermined area of the memory 12m as the CAN node that can communicate in the sub network N, and the process proceeds to the step S4. When the CAN datum includes a last-node datum showing the last node, the datum is stored in the memory 12m.

In the step S4, it is judged whether or not the CAN datum from the last slave communication apparatus 10s is received with reference to existence of the last-node datum in the received CAN datum. When it is judged that the CAN datum from the last slave communication apparatus 10s is not received (N in the step S4), the process returns to the step S2, and this process is repeated. When it is judged that the CAN datum from the last slave communication apparatus 10s is received (Y in the step S4), the process proceeds to the step S5.

In the step S5, the maximum value of the CAN nodes stored in the memory 12m is stored as the number of the slave nodes. In the step S6, node information indicating the number of slave nodes is generated and the frame for sending this information is generated and outputted to the main communication device 14. The frame is transmitted through the main transmission line M to the meter unit 50 or a like, and the process is finished.

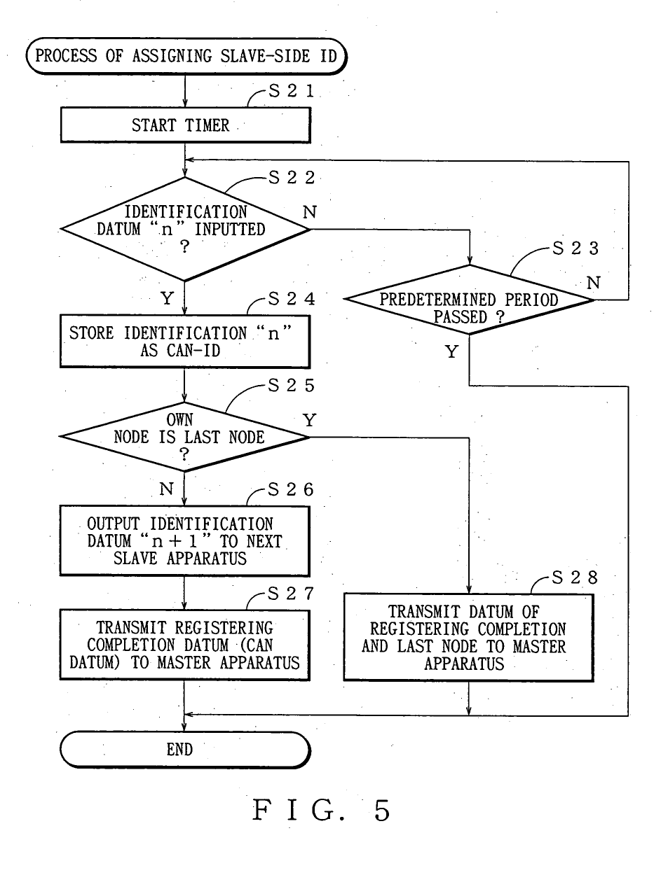

FIG. 5 is a flowchart of the first embodiment of a process of assigning a slave-side ID executed by a CPU 11s in a slave communication apparatus 10s. The first embodiment of the process of assigning the slave-side ID executed by the CPU 11s in the slave communication apparatus 10s in the above structure is described with reference to the flowchart in FIG. 5. After the CPU 11s is started when electric power is supplied to the slave communication apparatus 10s by turning the ignition switch of the vehicle (not shown) ON, the process of assigning the slave-ID is called from an upper module.

In the step S21, a timer (not shown) making timeout after passing a predetermined period is started, and in the step S22, it is judged whether or not the identification datum “n” from the input device 16 is inputted. When it is judged that the identification datum is not inputted (N in the step S22), the process proceeds to the step 23.

In the step 23, it is judged whether or not the predetermined period passes by judgement of the timeout of the timer (not shown). When it is judged that the timer does not make timeout, that is, when it is judged that the predetermined period does not pass (N in the step S23), the process returns to the step S22, and this serial process is repeated. When it is judged that the timer makes timeout, that is, when it is judged that the predetermined period passes (Y in the step S23), the process is finished.

When it is judged that the identification datum is inputted in the step S22 (Y in the step S22), the identification datum “n” set as the CAN-ID is stored in the memory 12s, and the process proceeds to the step S25.

In the step S25, it is judged whether or not the own slave communication apparatus 10s is the last node with reference to the level condition of UART of the output device 17. When it is judged that the UART of the output device 17 is High level, that is, when it is judged that the own slave communication apparatus 10s is not the last node (N in the step S25), the process proceeds to the step S26.

In the step S26, the identification datum “n+1” of the next(lower) slave communication apparatus 10s connected with the output device 17 is generated, and the parallel signal of the identification datum is outputted to the output device 17. The serial signal converted from the parallel signal in the output device 17 is inputted to the input device 16 of the next slave communication device 10s, and the process proceeds to the step S27.

In the step S27, the frame (CAN datum, notice information, and a like) having the registering completion datum for notifying the master communication apparatus 10m of completion of registering the set identification datum, the identification datum, and a like, is generated. The frame is outputted to the local communication device 13, and transmitted through the transmission line L to the master communication apparatus 10m. Thereafter, the process is finished.

When it is judged that the UART is in the Low level condition in the step S25, that is, when it is judged that the own slave communication apparatus 10s is the last node (Y in the step S25) in the step S28, the frame having the registering completion datum for notifying the master communication apparatus 10m of completion of registering the set identification datum, the last node datum informing the last node (CAN datum, notice information, and a like) is generated. The frame is outputted to the local communication device 13, and transmitted through the transmission line L to the master communication apparatus 10m. Thereafter, the process is finished.

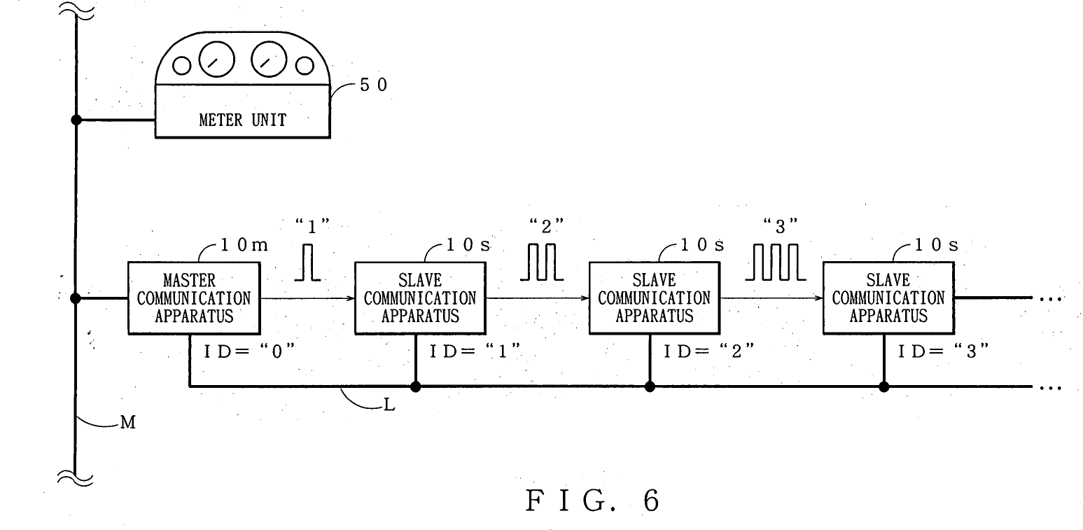

An example of actions of the communication system 100 of the first embodiment in the above structure is described with reference to FIG. 6. FIG. 6 is a schematic diagram for describing an action of the communication system 100.

When it is started by operation of turning ON the ignition key of the vehicle that the electric power is supplied, the master communication apparatus 10m recognizes to be requested for assigning the identification datum. The master apparatus 10m sets the identification datum of the its node “0”, and generates the identification datum “1” of the slave communication apparatus 10s connected with the output device 15. The serial signal indicating the identification datum “1” is outputted from the output device 15.

When the serial signal is inputted to the input device 16, the slave communication apparatus 10s sets the identification datum “1” as the identification datum “1” of the its node. The identification datum of the next (lower) slave communication apparatus 10s connected with the output device 17 is generated as “2” serially to the set identification datum “1”. The serial signal of the identification datum “2” is outputted from the output device 17 to the next (lower) slave communication apparatus 10s. The notice information (CAN datum) indicating the identification datum “1” and completion of setting the identification datum is generated. The notice information is transmitted through the transmission line L to the master communication apparatus 10m by the local communication device 13s.

The next slave communication apparatus 10s sets the inputted datum as the identification datum “2” of the its node, as same as the slave communication apparatus 10s of the identification datum “1”. The identification datum of the next (lower) slave communication apparatus 10s connected with the output device 17 is generated as “3” serially to the set identification datum “2”. The serial signal of the identification datum “3” is outputted from the output device 17 to the next (lower) slave communication apparatus 10s. The notice information (CAN datum) indicating the identification datum “1” and completion of setting the identification datum is generated. The notice information is transmitted through the transmission line L to the master communication apparatus 10m by the local communication device 13s.

When the other slave communication apparatuses 10s complete to set the respective identification data “3” to “n” in serial as mentioned above, the other slave communication apparatuses 10s transmit the notice information (CAN data) to the master communication apparatus 10m. When it is recognized that the slave communication apparatus 10s set with the identification datum “n” is the last node, the notice information indicating the completion of registration and the last node (CAN datum) is generated. The notice information is transmitted through the transmission line L to the master communication apparatus 10m by the local communication device 13s.

The master communication apparatus 10m recognizes the slave communication apparatus 10s allowable to communicate with reference to the received notice information (CAN data). When the notice information indicating completion of registration and the last node is received from the slave communication apparatus 10s of the last node, the master communication apparatus 10m generates a node information indicating a number of slave nodes. The master communication apparatus 10m transmits the information through the main transmission line M to the meter unit 50, and the node information is shown in the meter unit 50. The master communication apparatus 10m and the plurality of slave communication apparatuses 10s allowable to communicate can be recognized by the shown information.

When a communication error, occurred between the master communication apparatus 10m and the slave communication apparatus 10s of the identification datum “2” corresponding to an occurrence of no response, is detected, information of communication error having the identification datum “2” of the slave communication apparatus 10s corresponding to the communication error. The information of communication error is transmitted through the main transmission line M to the meter unit 50, and shown at the meter unit 50. Thus, the identification datum “2” is recognized, and the slave communication apparatus 10s connected second from the master communication apparatus 10m is known as the apparatus having the communication error and maintained.

When each of the master communication apparatus 10m and the slave communication apparatuses 10s is inputted a detection datum of detecting voltage drop of the each battery unit B from the battery unit B, the each apparatus generates a battery information for indicating an abnormal condition of the battery unit B and transmits the information to the meter unit 50.

When the slave communication apparatus 10s transmits the battery information, the information is transmitted through the transmission line L to the master communication apparatus 10m, and the master communication apparatus 10m transfers the information to the meter unit 50. According to the embodiment, the master communication apparatus 10m performs as a gateway for the main transmission line M.

As mentioned above, the output device 15 (the master-side output device) provided at the master communication apparatus 10m is connected with the input device 16 provided at the slave communication apparatus 10s. Thereafter, the slave-apparatus identification datum generated according to detection of the start of assigning the datum at the master communication apparatus 10m is outputted from the output device 15 to the slave communication apparatus 10s. Then, the slave communication apparatus 10s sets the inputted datum as the identification datum. Thereby, the slave communication apparatus 10s is not required to store a pre-assigned identification datum.

The identification datum of the next (lower) slave communication apparatus 10s connected with the output device 17 is generated with reference to the identification datum set at the slave communication apparatus 10s. By connecting the slave communication apparatuses 10s in a row, the each identification datum can be set automatically for each slave communication apparatus 10s. The master communication apparatus 10m detects the start of assigning the identification datum. Therefore, by defining the start with the time of starting electric power supply to the master communication apparatus 10m, the time of completing connection, the identification datum can be set at a suitable time and change of a number of slave communication apparatuses 10s can be adapted easily.

Therefore, the slave communication apparatuses 10s are not required to store the pre-assigned identification datum, so that the slave communication apparatus 10s can be used in common, and cost reduction of the communication apparatus having a lot of slave communication apparatuses 10s can be accomplished.

The notice information for notifying the identification datum set by the slave communication apparatus 10s is transmitted through the transmission line L to the master communication apparatus 10m, and the master communication apparatus 10m recognizes the transmittable slave communication apparatuses 10s with reference to the received notice information. Thereby, the master communication apparatus 10m can recognizes the transmittable slave communication apparatus 10s and also the identification datum set at the slave communication apparatus 10s.

The identification datum of the other slave communication apparatus 10s connected with the output device 17 is generated to be serial to the identification datum set at the slave communication apparatus 10s. When a communication error occurred between the master communication apparatus 10m and slave communication apparatus 10s is detected at the master communication apparatus 10m, the information of the communication error having the identification datum of the slave communication apparatus 10s corresponding to the communication error is generated and transmitted to the meter unit 50 connected with the main transmission line M. Thereby, The slave communication apparatus 10s defined in the communication error with reference to the identification datum of the information of the communication error can be identified at a mating apparatus, so that maintenance at a time of the communication error can be supported by the information of the communication error.

In the first embodiment mentioned above, all slave communication apparatuses 10s transmit the registering completion datum to the master communication apparatus 10m. This invention is not limited to the above example. It can have various changes, for example, in which only the slave communication apparatus 10s of the last node transmits the registering completion datum to the master communication apparatus 10m.

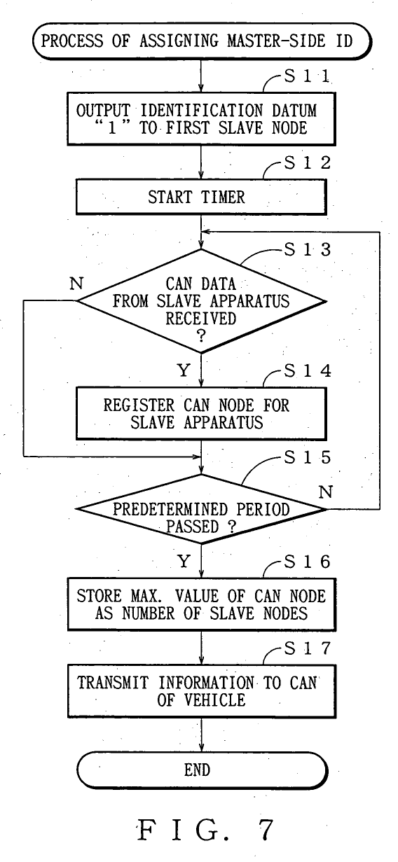

FIG. 7 is a flowchart of a second embodiment of a process of assigning a master-side ID executed by a CPU 11m in a master communication apparatus. The process of assigning the master-ID is called from an upper module, as same as the first embodiment.

In the step S11, “0” as an identification datum of an own node is set in the memory 12m, and an identification datum “1” of the front slave communication apparatus 10s connected with the (master-side) output device 15 is generated. A parallel signal of the identification datum is outputted to the output device 15. A serial signal converted from the parallel signal in the output device 15 is inputted to the input device 16 of the slave communication apparatus 10s, and the process proceeds to the step S12.

In the step S12, the timer (not shown) making timeout after passing a predetermined period is started, and the process proceeds to the step S13. The predetermined period is determined as a period based on a time required for setting and registering the identification datum of the slave communication apparatus 10s and a number of the slave communication apparatuses 10s capable to be set.

In the step S13, it is judged with reference to the input data from the local communication device 13m whether or not a CAN datum from the slave communication apparatus 10s is received. When it is judged that the CAN data is not received (N in the step S13), that is, when notice information for notifying completion of registering the identification datum at the slave communication apparatus 10s is not received, the process proceeds to the step S15. When it is judged that the CAN data is received (Y in the step S13), there exists the slave communication apparatus 10s, in which the identification datum is registered completely, and the process proceeds to the step S14.

In the step S14, the slave node (identification datum) included in the received CAN datum is additionally stored sequentially in a predetermined area of the memory 12m as the CAN node that can communicate in the sub network N, and the process proceeds to the step S15.

In the step 15, it is judged whether or not the predetermined period passes by judgement of the timeout of the timer. When it is judged that the timer does not make timeout, that is, when it is judged that the predetermined period does not pass (N in the step S15), the process returns to the step S13, and this serial process is repeated. When it is judged that the timer makes timeout, that is, when it is judged that the predetermined period passes (Y in the step S15), the process proceeds to the step S16.

In the step S16, a maximum value of the CAN nodes stored in the memory 12m is stored as the number of the slave nodes. In the step S17, node information indicating the number of slave nodes is generated and a frame for sending this information is generated and outputted to the main communication device 14. The frame is transmitted through the main transmission line M to the meter unit 50 or a like, and the process is finished.

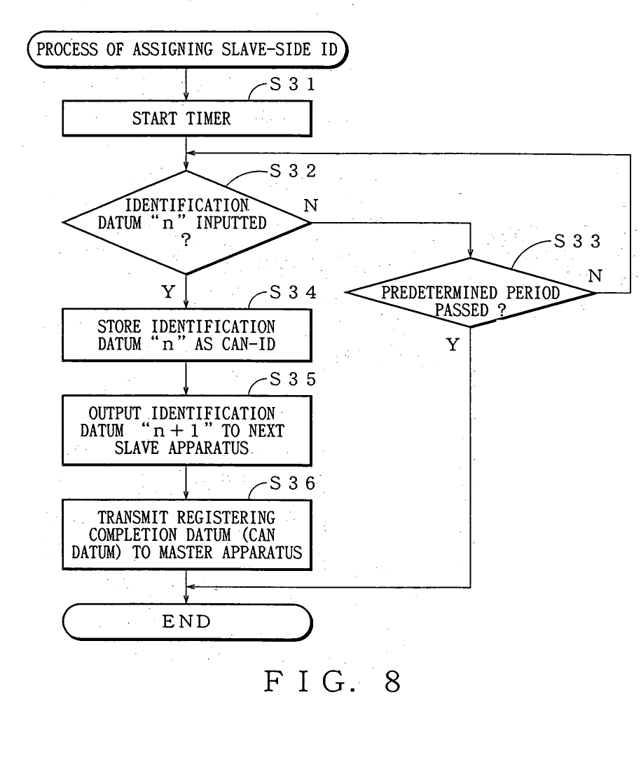

FIG. 8 is a flowchart of the second embodiment of a process of assigning a slave-side ID executed by a CPU 11s in a slave communication apparatus 10s. After the CPU 11s is started, the process of assigning the slave-ID is called from an upper module as same as the first embodiment.

In the step S31, the timer (not shown) making timeout after passing a predetermined period is started, and in the step S32, it is judged whether or not an identification datum “n” from the input device 16 is inputted. When it is judged that the identification datum is not inputted (N in the step S32), the process proceeds to the step 33.

In the step 33, it is judged whether or not the predetermined period passes by judgement of the timeout of the timer. When it is judged that the timer does not make timeout, that is, when it is judged that the predetermined period does not pass (N in the step S33), the process returns to the step S32, and this serial process is repeated. When it is judged that the timer makes timeout, that is, when it is judged that the predetermined period passes (Y in the step S33), the process is finished.

When it is judged that the identification datum is inputted in the step S32 (Y in the step S32), the identification datum “n” set as the identification datum is stored in the memory 12s. In the step S35, an identification datum “n+1” of the next (lower) slave communication apparatus 10s connected with the output device 17 is generated, and a parallel signal of the identification datum is outputted to the output device 17. A serial signal converted from the parallel signal in the output device 17 is inputted to the input device 16 of the next slave communication device 10s, and the process proceeds to the step S36.

In the step S36, a frame (CAN datum, notice information, and a like) having a registering completion datum for notifying the master communication apparatus 10m of completion of registering the set identification datum, the identification datum, and a like, is generated. The frame is outputted to the local communication device 13, and transmitted through the transmission line L to the master communication apparatus 10m. Thereafter, the process is finished.

Operations (actions) of the communication system 100 according to the second embodiment of the process of assigning an ID executed by the CPU 11m are basically same as the operations of the communication system 100 according to the first embodiment of the process of assigning an ID executed by the CPU 11m. It differs from the first embodiment of the process of assigning an ID that the master communication apparatus 10m recognizes the transmittable slave apparatuses 10s with reference to the registering completion datum received from a time of outputting the identification datum “1” to the slave communication apparatus 10s of the front slave node until the predetermined period passes. Thereby, the slave communication apparatus 10s is not required to judge whether or not itself is the last node so that the slave communication apparatus 10s can be simplified.

The communication apparatus 10m, 10s and the communication system 100 according to the second embodiment of the process of assigning an ID of the present invention can have the same effects as those according to the first embodiment of the process of assigning an ID. The slave communication apparatus 10s is not required to store the identification datum assigned previously. Thereby, the slave communication apparatus 10s can be used in common, and cost reduction of the communication apparatus having a lot of slave communication apparatuses 10s can be accomplished.

In the embodiments mentioned above, the communication system 100 structured with the master communication apparatus 10m and the plurality of slave communication apparatuses 10s is used as a communicating function of the battery units B. This invention is not limited to the above example. The communication system 100 can be applied for seat control as a sub network of a vehicle body system, control for a device including a plurality of the same function nodes, for example, switch control of an audio device and an air conditioner, and a like.

The present invention can be applied not only to the communication system in a vehicle, but also to the communication systems, which assigns Ids in a network connected with a plurality of terminal devices and communicates with reference to IDs, for example, a network installed in a bus, an airplane, a ship, and a like.

Although the present invention has been fully described by way of examples with reference to the accompanying drawings, it is to be noted that various change and modifications can be made with the scope of the present invention as defined by the following claims.

1. A communication apparatus, being connected with a transmission line and having a communication device, which communicates with the other communication apparatuses connected with the transmission line with reference to an identification datum to be assigned to each communication apparatus, comprising:
an input device being connected through a connecting cable with the upper other communication apparatus, which is connected with the transmission line, the input device being inputted a datum from the upper other communication apparatus;
an output device being connected through the connecting cable with the lower other communication apparatus, which is connected with the transmission line, the output device outputting the datum to said lower other communication apparatus;
an identification data setting device for setting the datum inputted from the input device to the identification datum of the communication apparatus;
an identification data generating device for generating the identification datum of the lower other communication apparatus connected with the output device with reference to the identification datum set by the identification data setting device; and
an output control device for controlling the output device to output the identification datum to be generated by the identification data generating device,
whereby the communication device communicates with the other communication apparatuses with reference to the identification datum set by the identification data setting device.

2. The communication apparatus according to claim 1, wherein the identification data generating device generates the identification datum of the lower other communication apparatus to be serial to the identification datum set by the identification data setting device.

3. The communication apparatus according to claim 1, wherein the communication apparatuses are connected with the transmission line to be a plurality of slave communication apparatuses of a communication system, which has a master communication apparatus connected with the transmission line, and communicates through the transmission line with reference to the identification datum to be applied to each communication apparatus, the plurality of slave communication apparatuses being connected in a row by sequentially connecting an output device of one slave communication apparatus and an input device of a next slave communication apparatus with the connecting cable, the master communication apparatus comprising:
a master-side output device being connected with the input device of a front one of the slave communication apparatuses connected in the row;
a start detecting device for detecting a start to assign the identification datum;
a slave-apparatus identification data generating device for generating the identification datum of the slave communication apparatus connected with the master-side output device corresponding to a detection of the start to assign the identification datum by the start detecting device; and
a master-side output control device for controlling the master-side output device to output the identification datum to be generated by the slave-apparatus identification data generating device.

4. The communication system according to claim 3, wherein the slave communication apparatus further comprises:
a notice information generating device for generating a notice information to give notice of the identification datum set by the identification data setting device; and
a transmission control device for controlling the communication device to transmit the notice information generated by the notice information generating device to the master communication apparatus,
wherein the master communication apparatus further comprises:
a master-side communication device for communicating through the transmission line; and
an identification device for identifying the slave communication apparatuses, which are transmittable, with reference to the notice information received by the master-side communication device corresponding to the output of the identification datum controlled by the master-side output control device,
wherein the master communication apparatus communicates by the master-side communication device with the slave communication apparatuses identified by the identification device.

5. The communication system according to claim 3, wherein the transmission line connected with the communication device of the slave communication apparatus and the master-side communication device of the master communication apparatus structures a sub network,
wherein the master communication apparatus further comprises:
a main communication device being connected with a main transmission line for communicating with a mating apparatus connected with the main transmission line, wherein said main transmission line connected through said main communication device with the sub network structures a main network;
an error detecting device for detecting a communication error to be occurred between the master-side communication device and the slave communication apparatus;
an information generating device for generating information of the communication error having the identification datum of the slave communication apparatus corresponding to the communication error detected by the error detecting device for giving notice of the communication error; and
a transmission request device for requesting the main communication device to transmit the information of the communication error generated by the information generating device to the mating apparatus.

6. The communication apparatus according to claim 2, wherein the communication apparatuses are connected with the transmission line to be a plurality of slave communication apparatuses of a communication system, which has a master communication apparatus connected with the transmission line, and communicates through the transmission line with reference to the identification datum to be applied to each communication apparatus, the plurality of slave communication apparatuses being connected in a row by sequentially connecting an output device of one slave communication apparatus and an input device of a next slave communication apparatus with the connecting cable, the master communication apparatus comprising:
a master-side output device being connected with the input device of a front one of the slave communication apparatuses connected in the row;
a start detecting device for detecting a start to assign the identification datum;
a slave-apparatus identification data generating device for generating the identification datum of the slave communication apparatus connected with the master-side output device corresponding to a detection of the start to assign the identification datum by the start detecting device; and
a master-side output control device for controlling the master-side output device to output the identification datum to be generated by the slave-apparatus identification data generating device.

7. The communication system according to claim 4, wherein the transmission line connected with the communication device of the slave communication apparatus and the master-side communication device of the master communication apparatus structures a sub network,
wherein the master communication apparatus further comprises:
a main communication device being connected with a main transmission line for communicating with a mating apparatus connected with the main transmission line, wherein said main transmission line connected through said main communication device with the sub network structures a main network;
an error detecting device for detecting a communication error to be occurred between the master-side communication device and the slave communication apparatus;
an information generating device for generating information of the communication error having the identification datum of the slave communication apparatus corresponding to the communication error detected by the error detecting device for giving notice of the communication error; and
a transmission request device for requesting the main communication device to transmit the information of the communication error generated by the information generating device to the mating apparatus.
